(19) United States
(12) Patent Application Publication
(10) Pub. No.: US 2024/0135248 A1
(43) Pub. Date: Apr. 25, 2024

(54) SUPPORT DEVICE, SUPPORT METHOD, AND PROGRAM

(71) Applicant: NIPPON TELEGRAPH AND TELEPHONE CORPORATION, Tokyo (JP)

(72) Inventors: Shota ORIHASHI, Tokyo (JP); Masato SAWADA, Tokyo (JP)

(73) Assignee: NIPPON TELEGRAPH AND TELEPHONE CORPORATION, Tokyo (JP)

(21) Appl. No.: 18/279,583

(22) PCT Filed: Mar. 1, 2021
(86) PCT No.: PCT/JP2021/007625

§ 371 Date: Aug. 29, 2023

(51) Int. Cl. G06N 20/00

(52) U.S. Cl. CPC G06N 20/00

(57) ABSTRACT

A support device according to the present disclosure includes a label inference unit that infers inference labels that are labels corresponding to elements included in training data in which elements and correct labels corresponding to the elements are associated with each other using a model that is learned using the training data and infers labels corresponding to the elements, and an evaluation unit that generates training data confirmation screens including elements included in the training data, correct labels of the elements, and inference labels of the elements.

### TECHNICAL FIELD

The present disclosure relates to a support device, a support method, and a program.

### BACKGROUND ART

In recent years, for the purpose of improving the service quality in a contact center, there has been proposed a system that performs voice recognition on call content in real time and automatically presents appropriate information to an operator who is receiving a call by making full use of natural language processing technology.

For example, Non Patent Literature 1 discloses a technique of presenting questions assumed in advance and answers to the questions (FAQ) to an operator in conversation between the operator and a customer. In this technology, conversation between an operator and a customer is subjected to voice recognition, and is converted into a semantic utterance text by “utterance end determination” for determining whether the speaker has finished speaking. Next, “service scene estimation” for estimating in which service scene in conversation the utterance corresponding to the utterance text is, such as greetings by the operator, confirmation of a requirement of the customer, response to the requirement, or closing of the conversation, is performed. The conversation is structured by the “service scene estimation”. From a result of the “service scene estimation”, “FAQ retrieval utterance determination” for extracting utterance including a requirement of the customer or utterance in which the operator confirms a requirement of the customer is performed. Retrieval using a retrieval query based on the utterance extracted by the “FAQ retrieval utterance determination” is performed on a database of the FAQ prepared in advance, and a retrieval result is presented to the operator.

For the above-described “utterance end determination”, “service scene estimation”, and “FAQ retrieval utterance determination”, a model constructed by learning training data in which labels for classifying utterance are assigned to utterance texts using a deep neural network or the like is used. Therefore, the “utterance end determination”, the “service scene estimation”, and the “FAQ retrieval utterance determination” can be regarded as a series of labeling problems for labeling a series of elements (utterance in conversation). Non Patent Literature 2 describes a technique of estimating a service scene by learning a large amount of training data in which labels corresponding to service scenes including a series of utterance is assigned to the utterance using a deep neural network including long and short term memory.

### CITATION LIST

### Non Patent Literature

Non Patent Literature 1: Takaaki Hasegawa, Yuichiro Sekiguchi, Setsuo Yamada, Masafumi Tamoto, “Automatic Recognition Support System That Supports Operator Service,” NTT Technical Journal, vol. 31, no. 7, pp. 16-19, July 2019.
Non Patent Literature 2: R. Masumura, S. Yamada, T. Tanaka, A. Ando, H. Kamiyama, and Y. Aono, “Online Call Scene Segmentation of Contact Center Dialogues based on Role Aware Hierarchical LSTM-RNNs,” Asia-Pacific Signal and Information Processing Association Annual Summit and Conference (APSIPA ASC), November 2018.

### SUMMARY OF INVENTION

### Technical Problem

In techniques described in Non Patent Literature 1 and 2 described above, a large amount of training data is required in order to set the estimation accuracy to a level for practical use. For example, according to Non Patent Literature 1, high estimation accuracy can be obtained by training data being created from conversation logs of a call center of about 1000 calls and a model being learned. The training data is created by workers (training data creators) assigning a label to each utterance text while referring to utterance texts obtained by voice recognition of utterance voice.

Training data needs to be created according to the application destination of the model learned using the training data (for example, for each industry of a contact center). As described above, since a large amount of training data is required in order to obtain high estimation accuracy, work of creating training data to be labeled is often performed by a plurality of workers. Here, since experience or a detailed policy of assigning labels is different for each of the workers, there is a case where a label is assigned differently, that is, a label is assigned differently even if the utterance has the same content. In a case where there is a difference in label in training data, the estimation accuracy of a model learned using the training data is deteriorated, and thus confirming whether the same label is consistently assigned to utterance having similar content is necessary. However, a technology that enables efficient confirmation of training data is not established, and analysis by tacit knowledge of an expert or repetition of try and error is necessary.

Therefore, there is a demand for a technology that enables more efficient performing of confirmation work of training data in creation of training data in which labels are assigned to elements such as utterance texts.

An object of the present disclosure made in view of the above issues is to provide a support device, a support method, and a program that enable more efficient confirmation work of training data.

### Solution to Problem

In order to solve the above issues, a support device according to the present disclosure is a support device that supports confirmation of training data including sets of elements and correct labels corresponding to the elements, the support device including a label inference unit that infers inference labels that are labels corresponding to elements included in the training data using a model that is learned using the training data and infers labels corresponding to the elements, and an evaluation unit that generates training data confirmation screens including elements included in the training data, correct labels of the elements, and inference labels of the elements.

Furthermore, in order to solve the above issues, a support method according to the present disclosure is a support method for supporting confirmation of training data including sets of elements and correct labels corresponding to the elements, the support method including a step of inferring inference labels that are labels corresponding to elements included in the training data using a model that is learned using the training data and infers labels corresponding to the elements, and a step of generating training data confirmation screens including elements included in the training data, correct labels of the elements, and inference labels of the elements.

Furthermore, in order to solve the above issues, a program according to the present disclosure causes a computer to function as the support device described above.

### Advantageous Effects of Invention

According to a support device, a support method, and a program according to the present disclosure, confirmation work of training data can be more efficiently performed.

### BRIEF DESCRIPTION OF DRAWINGS

FIG. 1 is a block diagram illustrating a schematic configuration of a computer that functions as a support device according to a first embodiment of the present disclosure.

FIG. 2 is a diagram illustrating a functional configuration example of the support device according to the first embodiment of the present disclosure.

FIG. 3 is a flowchart illustrating an example of operation of the support device illustrated in FIG. 2.

FIG. 4 is a diagram illustrating an example of call-specific evaluation results by a call-specific inference result evaluation unit illustrated in FIG. 2.

FIG. 5 is a diagram illustrating an example of call-specific confirmation screens generated by a call-specific confirmation screen generation unit illustrated in FIG. 2.

FIG. 6 is a diagram illustrating another example of the call-specific confirmation screens generated by the call-specific confirmation screen generation unit illustrated in FIG. 2.

FIG. 7 is a diagram illustrating an example of utterance-specific evaluation results by an utterance-specific inference result evaluation unit illustrated in FIG. 2.

FIG. 8 is a diagram illustrating an example of utterance-specific confirmation screens generated by an utterance-specific confirmation screen generation unit illustrated in FIG. 2.

FIG. 9 is a diagram illustrating a functional configuration example of a support device according to a second embodiment of the present disclosure.

FIG. 10 is a flowchart illustrating an example of operation of the support device illustrated in FIG. 9.

FIG. 11 is a diagram illustrating a functional configuration example of a support device according to a third embodiment of the present disclosure.

FIG. 12 is a flowchart illustrating an example of operation of the support device illustrated in FIG. 11.

FIG. 13 is a diagram illustrating an example of training data creator evaluation results by a training data creator evaluation unit illustrated in FIG. 11.

FIG. 14 is a diagram illustrating an example of call-specific evaluation results by a call-specific inference result evaluation unit illustrated in FIG. 11.

FIG. 15 is a diagram illustrating an example of call-specific confirmation screens generated by a call-specific confirmation screen generation unit illustrated in FIG. 11.

FIG. 16 is a diagram illustrating an example of utterance-specific evaluation results by an utterance-specific inference result evaluation unit illustrated in FIG. 11.

FIG. 17 is a diagram illustrating another example of utterance-specific evaluation results by an utterance-specific inference result evaluation unit illustrated in FIG. 11.

FIG. 18 is a diagram illustrating an example of utterance-specific confirmation screens generated by an utterance-specific confirmation screen generation unit illustrated in FIG. 11.

FIG. 19 is a diagram illustrating an example of structure of labels including a plurality of items.

### DESCRIPTION OF EMBODIMENTS

Hereinafter, embodiments of the present disclosure will be described with reference to the drawings.

### First Embodiment

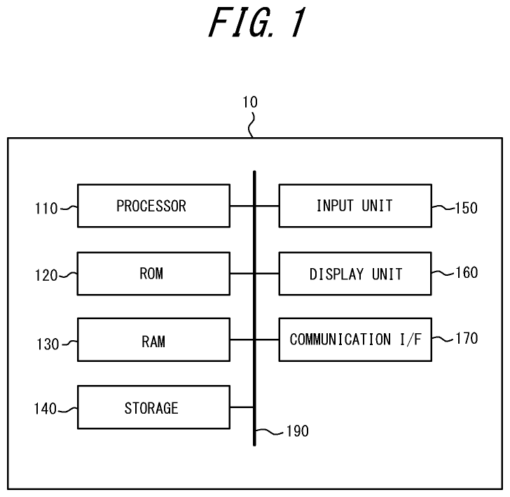

FIG. 1 is a block diagram illustrating a hardware configuration in a case where a support device 10 according to a first embodiment of the present disclosure is a computer capable of executing a program command. Here, the computer may be a general-purpose computer, a dedicated computer, a workstation, a personal computer (PC), an electronic note pad, or the like. The program command may be a program code, code segment, or the like for executing a necessary task.

As illustrated in FIG. 1, the support device 10 includes a processor 110, a read only memory (ROM) 120, a random access memory (RAM) 130, a storage 140, an input unit 150, a display unit 160, and a communication interface (I/F) 170. The components are communicably connected to each other via a bus 190. Specifically, the processor 110 is a central processing unit (CPU), a micro processing unit (MPU), a graphics processing unit (GPU), a digital signal processor (DSP), a system on a chip (SoC), or the like and may be configured by the same or different types of a plurality of processors.

The processor 110 executes control of the components and various types of arithmetic processing. That is, the processor 110 reads a program from the ROM 120 or the storage 140 and executes the program using the RAM 130 as a working area. The processor 110 executes control of the above components and various types of arithmetic processing according to a program stored in the ROM 120 or the storage 140. In the present embodiment, a program according to the present disclosure is stored in the ROM 120 or the storage 140.

The program may be provided in a form in which the program is stored in a non-transitory storage medium, such as a compact disk read only memory (CD-ROM), a digital versatile disk read only memory (DVD-ROM), and a universal serial bus (USB) memory. The program may be downloaded from an external device via a network.

The ROM 120 stores various programs and various types of data. The RAM 130 temporarily stores a program or data as a working area. The storage 140 includes a hard disk drive (HDD) or a solid state drive (SSD) and stores various programs including an operating system and various types of data.

The input unit 150 includes a pointing device such as a mouse and a keyboard and is used to perform various inputs.

The display unit 160 is, for example, a liquid crystal display, and displays various types of information. A touch panel system may be adopted so that the display unit 160 can function as the input unit 150.

The communication interface 170 is an interface for communicating with another device such as an external device (not illustrated), and for example, a standard such as Ethernet (registered trademark), FDDI, and Wi-Fi (registered trademark) is used.

Next, a functional configuration of the support device 10 according to the present embodiment will be described.

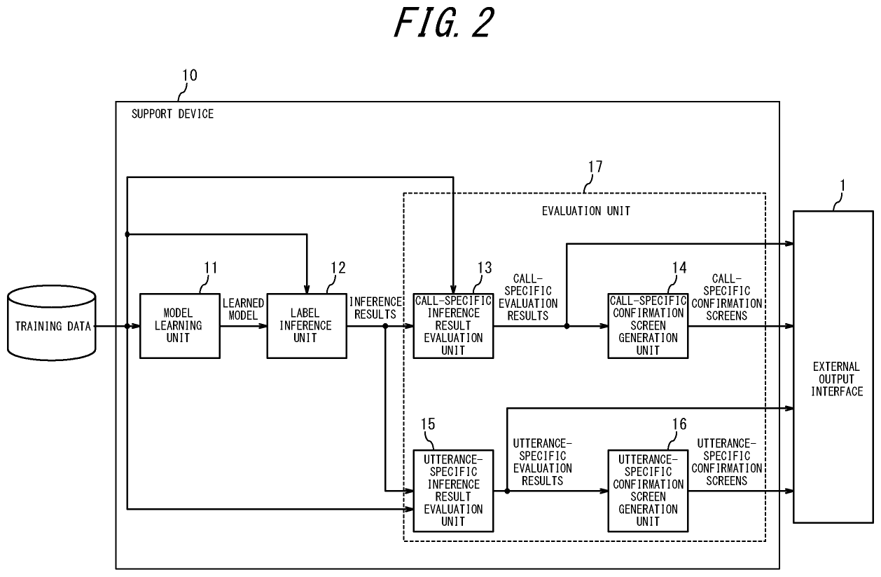

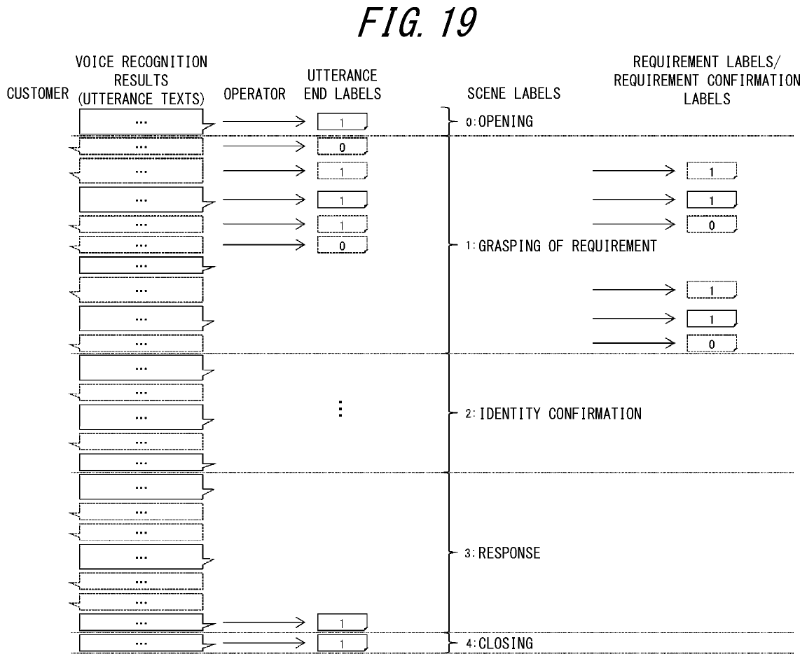

FIG. 2 is a diagram illustrating a configuration example of the support device 10 according to the present embodiment. The support device 10 according to the present embodiment supports, for example, confirmation work of training data including sets of elements and labels assigned to the elements (hereinafter, referred to as “correct labels”) such as confirmation of the presence or absence of a difference in label assignment criteria performed by workers who create the training data. Note that the correct labels are merely labels assigned at the time of creating training data, and are targets of the confirmation work. Therefore, assigned correct labels are not necessarily correct. Supporting confirmation of training data facilitates extracting a label that needs to be corrected, and thus the efficiency of correction work of the training data can be improved. Hereinafter, an example in which labels are assigned to utterance texts obtained by performing voice recognition on utterance in conversation by a plurality of speakers (operator and customer) at a contact center as illustrated in FIG. 19 will be described. In FIG. 19, utterance texts corresponding to utterance of the operator (hereinafter, the utterance texts corresponding to the utterance may be simply referred to as “utterance texts”) are indicated by solid-line balloons, and utterance texts of the customer are indicated by dotted-line balloons.

In the example illustrated in FIG. 19, by utterance end labels each indicating whether the utterance is utterance end utterance being assigned to respective utterance texts, training data for “utterance end determination” is created. Furthermore, by scene labels each indicating the service scene including the utterance being assigned to the respective utterance texts, training data for “service scene estimation” is created. Furthermore, by requirement labels each indicating that the utterance is utterance indicating a requirement of the customer being assigned to utterance indicating a requirement of the customer among utterance included in a service scene of “grasping requirement” for grasping a requirement of the customer, and requirement confirmation labels each indicating that the utterance is utterance for confirming a requirement of the customer being assigned to utterance for confirming a requirement of the customer by the operator, training data for “FAQ retrieval utterance determination” is created. However, the present disclosure is not limited to the example of the training data illustrated in FIG. 19, and can be applied to training data including sets of a plurality of any elements and labels of each of the elements. Furthermore, an utterance text may be not only utterance in a call converted into a text, but also utterance in text conversation such as chat. Furthermore, a speaker in conversation is not limited to a human, and may be a robot, a virtual agent, or the like.

As illustrated in FIG. 2, the support device 10 according to the present embodiment includes a model learning unit 11, a label inference unit 12, a call-specific inference result evaluation unit 13, a call-specific confirmation screen generation unit 14, an utterance-specific inference result evaluation unit 15, and an utterance-specific confirmation screen generation unit 16. The call-specific inference result evaluation unit 13, the call-specific confirmation screen generation unit 14, the utterance-specific inference result evaluation unit 15, and the utterance-specific confirmation screen generation unit 16 form an evaluation unit 17. The model learning unit 11, the label inference unit 12, the call-specific inference result evaluation unit 13, the call-specific confirmation screen generation unit 14, the utterance-specific inference result evaluation unit 15, and the utterance-specific confirmation screen generation unit 16 may be formed by dedicated hardware such as an application specific integrated circuit (ASIC) or a field-programmable gate array (FPGA), or may be formed by one or more processors as described above.

Training data including sets of utterance texts (elements) and correct labels assigned to the utterance texts is input to the model learning unit 11. The model learning unit 11 learns a model that infers labels corresponding to utterance texts using the input training data. As a model learning method, any learning method can be applied according to the purpose of a system to which the model is applied. The model learning unit 11 outputs a model created by the learning of the training data (hereinafter, the model is referred to as a “learned model”) to the label inference unit 12. Note that the learned model may be prepared in advance. Therefore, the support device 10 may not include the model learning unit 11.

The label inference unit 12 receives the training data and the learned model created by the model learning unit 11. The training data input to the label inference unit 12 is the same as the training data used for the learning of the learned model. The label inference unit 12 infers labels of utterance texts (elements) included in the training data using the learned model (hereinafter, the labels inferred by the learned model are referred to as “inference labels”). The label inference unit 12 outputs the inference labels of the respective utterance texts included in the training data to the call-specific inference result evaluation unit 13 and the utterance-specific inference result evaluation unit 15 as inference results.

The evaluation unit 17 compares the correct labels assigned to the elements included in the training data with the inference labels inferred by the label inference unit 12 and performs evaluation, and outputs evaluation results to an external output interface 1. Furthermore, the evaluation unit 17 generates training data confirmation screens for confirmation of the training data including the elements included in the training data, the correct labels assigned to the elements, and the inference labels of the elements. The evaluation unit 17 outputs the generated training data confirmation screens to the external output interface 1.

The external output interface 1 is a device used by workers who perform creation and correction work of training data or a manager who manages work by the workers. The external output interface 1, for example, displays and presents comparison results between the correct labels assigned to the training data and the inference labels inferred by the learned model that are output from the evaluation unit 17. The external output interface 1 may have any configuration as long as it includes a function of communicating with the support device 10, a function of presenting (displaying) evaluation results of the evaluation unit 17, training data confirmation screens, and the like, and a function of receiving an operation input.

As described above, the evaluation unit 17 includes the call-specific inference result evaluation unit 13, the call-specific confirmation screen generation unit 14, the utterance-specific inference result evaluation unit 15, and the utterance-specific confirmation screen generation unit 16.

The call-specific inference result evaluation unit 13 receives the training data and the inference results of the label inference unit 12. Usually, the training data includes utterance text groups each including a plurality of utterance texts in a call by a plurality of speakers for a plurality of calls. That is, training data includes a plurality of element groups each including a plurality of elements in series. The call-specific inference result evaluation unit 13 evaluates the input training data and the inference results of the label inference unit 12 for each of the calls. The call-specific inference result evaluation unit 13 outputs evaluation results (call-specific evaluation results) to the call-specific confirmation screen generation unit 14 and the external output interface 1. Details of the call-specific evaluation results will be described below.

The call-specific confirmation screen generation unit 14 generates training data confirmation screens for the respective calls (hereinafter, the screens are referred to as “call-specific confirmation screens”) on the basis of the call-specific evaluation results output from the call-specific inference result evaluation unit 13, and outputs the call-specific confirmation screens to the external output interface 1. Details of the call-specific confirmation screens will be described below.

The utterance-specific inference result evaluation unit 15 receives the training data and the inference results of the label inference unit 12. The utterance-specific inference result evaluation unit 15 evaluates the input training data and the inference results of the label inference unit 12 for each piece of utterance. The utterance-specific inference result evaluation unit 15 outputs evaluation results (utterance-specific evaluation results) to the utterance-specific confirmation screen generation unit 16 and the external output interface 1. Details of the utterance-specific evaluation results will be described below.

The utterance-specific confirmation screen generation unit 16 generates training data confirmation screens for respective pieces of the utterance (hereinafter, the screens are referred to as “utterance-specific confirmation screens”) on the basis of the utterance-specific evaluation results output from the utterance-specific inference result evaluation unit 15, and outputs the utterance-specific confirmation screens to the external output interface 1. Details of the utterance-specific confirmation screens will be described below.

In the present embodiment, the training data confirmation screens including the utterance texts (elements) included in the training data, the correct labels assigned to the utterance texts, and the inference labels inferred by the learned model learned using the training data are generated. Therefore, according to the support device 10 according to the present embodiment, since workers can easily confirm the training data by comparing the correct labels and the inference labels of the elements on the training data confirmation screens, the efficiency of training data confirmation work can be improved. Furthermore, since the efficiency of the training data confirmation work is improved, labels that need to be corrected can be easily extracted, and the efficiency of label correction work can also be improved.

Next, operation of the support device 10 according to the present embodiment will be described.

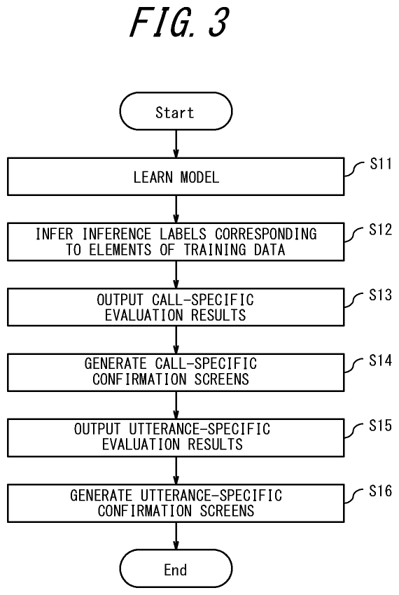

FIG. 3 is a flowchart illustrating an example of the operation of the support device 10, and is a diagram for describing a support method by the support device 10 according to the present embodiment.

The model learning unit 11 learns a model that infers labels for distinguishing utterance texts using training data (step S11).

The label inference unit 12 infers inference labels corresponding to elements of the training data using the learned model learned by the model learning unit 11 (step S12). As described above, the training data used for learning of the learned model is the same as the training data used for the training data inference processing by the label inference unit 12.

The call-specific inference result evaluation unit 13 evaluates the training data and inference results of the label inference unit 12 for each call, and outputs evaluation results (call-specific evaluation results) (step S13). Specifically, the call-specific inference result evaluation unit 13 compares, for each call, differences between correct labels assigned to utterance texts included in the training data and the inference labels inferred by the label inference unit 12. Then, the call-specific inference result evaluation unit 13 arranges evaluation values for respective calls in order from a call having the worst evaluation result (for example, utterance having an evaluation value equal to or less than a threshold) and outputs the evaluation values as call-specific evaluation results. That is, the call-specific inference result evaluation unit 13 outputs the evaluation results for respective element groups (calls including a plurality of pieces of utterance) in order from an element group having the worst evaluation result. As an evaluation value of a call, precision, recall, an f1-score, a matching rate, or the like between the correct labels and the inference labels of the respective utterance texts included in the training data can be used.

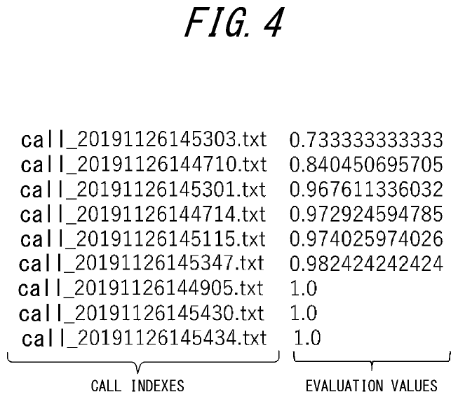

FIG. 4 is a diagram illustrating an example of the call-specific evaluation results.

As illustrated in FIG. 4, the call-specific inference result evaluation unit 13 outputs, as the call-specific evaluation results, call indexes that are identification information for identifying the calls and the evaluation values such as matching rates in the calls in association with each other. Here, the call-specific inference result evaluation unit 13 lists the call indexes and the evaluation values in order from the worst evaluation result, and outputs the list as text data, for example. The call-specific evaluation results may include the start time and the end time of the calls.

Referring back to FIG. 3, the call-specific confirmation screen generation unit 14 generates call-specific confirmation screens on the basis of the call-specific evaluation results (step S14) and outputs the screens to the external output interface 1.

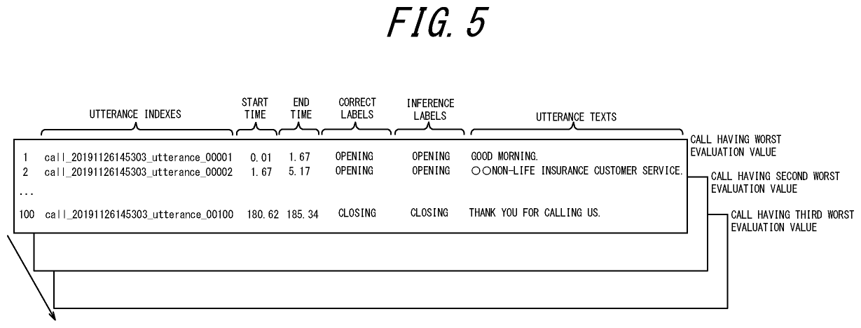

FIG. 5 is a diagram illustrating an example of the call-specific confirmation screens.

As illustrated in FIG. 5, the call-specific confirmation screen generation unit 14 generates the call-specific confirmation screens for the respective calls each including start time that is time when utterance included in the call is started, end time that is time when the utterance is ended, utterance texts, and correct labels and inference labels of the respective utterance texts. In this manner, the call-specific confirmation screen generation unit 14 generates the training data confirmation screens including the elements included in the training data, the correct labels of the elements, and the inference labels of the elements. Specifically, the call-specific confirmation screen generation unit 14 generates the training data confirmation screens indicating the correct labels and the inference labels corresponding to the elements included in the training data in a comparable manner (for example, as illustrated in FIG. 5, the correct labels and the inference labels corresponding to the elements are illustrated side by side). Here, the call-specific confirmation screen generation unit 14 presents the call-specific confirmation screens in order from a call having the worst evaluation result. For example, as illustrated in FIG. 5, the call-specific confirmation screen generation unit 14 may display the call-specific confirmation screens such that a call having a worse evaluation result is closer to the front. That is, the call-specific confirmation screen generation unit 14 may generate the call-specific confirmation screens for the elements such that confirmation can be performed in order from a call having the worst evaluation result. As described above, the call-specific confirmation screens each include the start time and the end time of utterance. Therefore, workers can confirm whether utterance overlaps. Note that the start time and the end time are not necessarily included in the call-specific confirmation screens.

In this manner, the call-specific inference result evaluation unit 13 included in the evaluation unit 17 evaluates, for each of the element groups, differences between the correct labels assigned to the elements included in the element groups and the inference labels inferred by the learned model. Furthermore, the call-specific confirmation screen generation unit 14 included in the evaluation unit 17 generates the training data confirmation screens for the respective element groups (call-specific confirmation screens) on the basis of the call-specific evaluation results, and presents the call-specific confirmation screens in order from an element group having the worst evaluation result.

Furthermore, the call-specific confirmation screen generation unit 14 included in the evaluation unit 17 may present the call-specific confirmation screens for the respective calls in a switchable manner. In the example illustrated in FIG. 5, the call-specific confirmation screen generation unit 14 may switch an utterance-specific confirmation screen to be displayed on the front in response to, for example, a switching operation by a worker. In this manner, the call-specific confirmation screen generation unit 14 may present the evaluation results for the respective element groups in a switchable manner.

By the call-specific confirmation screens for the respective calls being presented, workers can find and correct training data having bad quality for each of the calls. Furthermore, by switching the call-specific confirmation screens for the respective calls being enabled, for example, workers can continuously confirm the evaluation results for the respective calls, and thus the efficiency of training data confirmation work can be improved. Furthermore, by the call-specific confirmation screens being generated so as to be confirmed in order from a call having the worst evaluation result, workers can find a tendency of training data having bad quality in units of calls and grasp a main point of correction. As a result, the efficiency of training data correction work can be improved. Note that, instead of presenting the call-specific confirmation screens illustrated in FIG. 5 in a switchable manner, the call-specific confirmation screen generation unit 14 may divide a file group of text data corresponding to the call-specific confirmation screens into directories or the like on the basis of the evaluation values for the respective calls and output the directories to the external output interface 1.

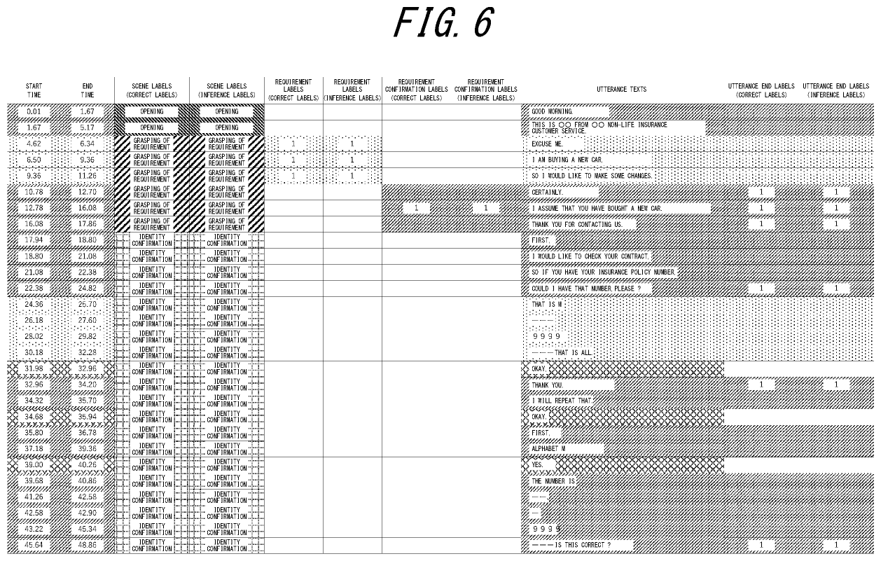

The call-specific confirmation screens are not limited to the example illustrated in FIG. 5. FIG. 6 is a diagram illustrating another example of the call-specific confirmation screens generated by the call-specific confirmation screen generation unit 14.

As illustrated in FIG. 6, the call-specific confirmation screen generation unit 14 may arrange the utterance texts of the operator and the customer in a line in chronological order on the call-specific confirmation screens. Furthermore, the call-specific confirmation screen generation unit 14 may arrange the start time at which the utterance starts, the end time at which the utterance ends, and labels assigned to the utterance (scene labels, requirement labels, requirement confirmation labels, and utterance end labels) in association with the respective utterance texts. As illustrated in FIG. 6, the call-specific confirmation screen generation unit 14 may display utterance texts of the operator and utterance text of the customer in different colors. Note that, in FIG. 6, a difference in color is expressed by a difference in hatching.

As illustrated in FIG. 6, the call-specific confirmation screen generation unit 14 may arrange a plurality of the elements in a line, and sort and arrange the labels of a plurality of items on one side and the other side of the elements corresponding to the labels on the basis of the structure of the labels of the plurality of items on the call-specific confirmation screens.

In general, arranging labels in areas close to utterance texts facilitates confirmation and correction work of the labels. Therefore, by the utterance texts being arranged in a line and the labels of the plurality of items being sorted and arranged on both sides of the utterance texts, the areas close to the utterance texts can be effectively utilized and the efficiency of confirmation and correction work of the labels.

In the example illustrated in FIG. 6, the scene labels, the requirement labels, and the requirement confirmation labels are arranged on the left side of the utterance texts, and the utterance end labels are arranged on the right side of the speed texts. In assigning a scene label, a requirement label, and a requirement confirmation label to an utterance text, not only the utterance text but also the content of utterance texts before and after the utterance text are considered. That is, a scene label, a requirement label, and a requirement confirmation label are labels assigned to an utterance text that are determined on the basis of the content of a plurality of utterance texts including the utterance text, that is, labels for which long-term context should be considered. On the other hand, assignment of an utterance end label to an utterance text only requires consideration of mainly only the utterance text. Therefore, the call-specific confirmation screen generation unit 14 may arrange the labels for which long-term context should be considered on the left side of the utterance text and arrange the label for which long-term context is not considered on the right side of the utterance text.

Furthermore, in the example illustrated in FIG. 6, the call-specific confirmation screen generation unit 14 arranges the requirement labels and the requirement confirmation labels closer to the utterance texts than the scene labels. Usually, a requirement label or a requirement confirmation label is assigned to an utterance text to which a scene label of “grasping of requirement” is assigned. That is, the scene labels are labels in a higher hierarchy, and the requirement labels/requirement confirmation labels are labels in a lower hierarchy. Therefore, the call-specific confirmation screen generation unit 14 may arrange labels having a lower hierarchy closer to the utterance texts among labels of a plurality of items having hierarchical structure. Since confirmation and correction work of the labels having a lower hierarchy is facilitated by the utterance texts being referred to, the work efficiency can be improved in this way. Furthermore, the utterance end labels are mainly assigned with the ends of the utterance being mainly focused on. Therefore, by the utterance end labels being arranged on the right side of the utterance texts, workers can easily refer to the ends of the utterance texts, and thus the work efficiency of confirmation and correction of the utterance end labels can be improved.

Furthermore, when a worker selects a label for correction work in correction work of the training data, the call-specific confirmation screen generation unit 14 may change the display mode of labels associated with the label to be corrected (label having a higher hierarchy and label having a lower hierarchy) on the basis of the hierarchical structure of the labels of the plurality of items. In the example illustrated in FIG. 6, it is assumed that a scene label of “grasping of requirement” is selected as a label to be updated. In this case, the call-specific confirmation screen generation unit 14 changes the display mode by, for example, changing the display colors of a requirement label and a requirement confirmation utterance label that are labels having a lower hierarchy of the scene label. As a result, workers can easily grasp labels associated with a label to be corrected, and the work efficiency of label assignment can be improved.

Furthermore, in a case where inconsistency occurs between associated labels when updating a label having a higher hierarchy or a label having a lower hierarchy, the call-specific confirmation screen generation unit 14 may change the display mode of the labels in which the inconsistency occurs. In this way, inconsistency can be prevented from occurring between labels of the plurality of items having hierarchical structure and the accuracy of label correction can be improved.

Furthermore, the call-specific confirmation screen generation unit 14 may make the display mode of an utterance text that is not a target of the training data, for example, a short utterance text such as a filler and “yes” different from other utterance texts. In this way, workers can easily grasp an utterance text in which a label does not need to be assigned, and thus the work efficiency can be improved.

Referring back to FIG. 3, the utterance-specific inference result evaluation unit 15 evaluates the training data and the inference results of the label inference unit 12 for each piece of the utterance, and outputs evaluation results (utterance-specific evaluation results) (step S15). The utterance-specific inference result evaluation unit 15 compares the labels of the training data with the labels of the inference results of the label inference unit 12 for each piece of the utterance, aggregates difference patterns that are patterns in which the labels of the training data and the labels of the inference results are different, and outputs the results as utterance-specific evaluation results.

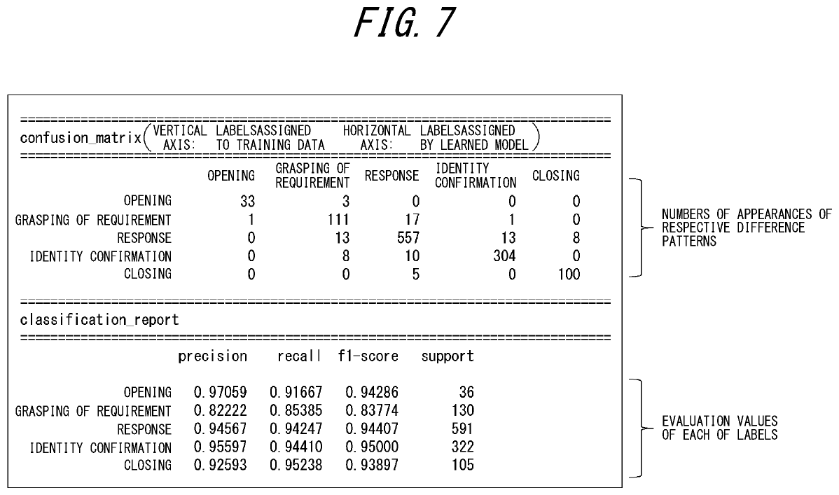

FIG. 7 is a diagram illustrating an example of the utterance-specific evaluation results.

As illustrated in FIG. 7, the utterance-specific inference result evaluation unit 15 outputs, as the utterance-specific evaluation results, for example, results indicating the numbers of appearances of the difference patterns by a confusion matrix and evaluation values of each of the labels (precision, recall, f1-score, and number of appearances (support)) as text data.

Referring back to FIG. 3, the utterance-specific confirmation screen generation unit 16 generates utterance-specific confirmation screens on the basis of the utterance-specific evaluation results (step S16) and outputs the screens to the external output interface 1.

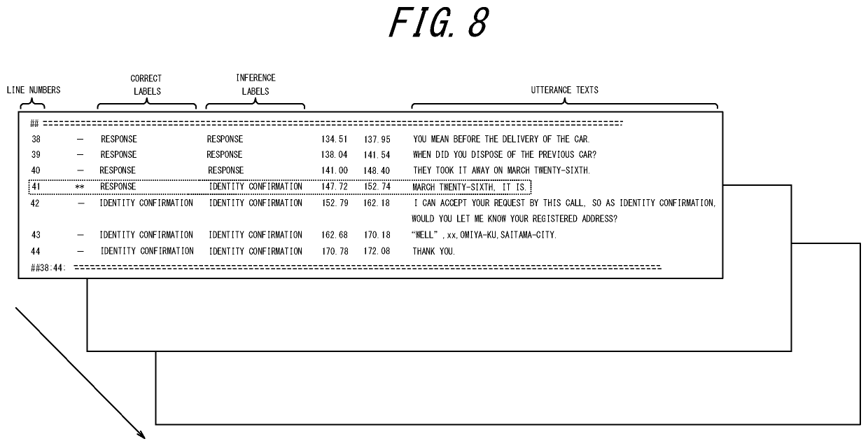

FIG. 8 is a diagram illustrating an example of the utterance-specific confirmation screens.

As illustrated in FIG. 8, the utterance-specific confirmation screen generation unit 16 generates the utterance-specific confirmation screens in which utterance texts, line numbers indicating the order of the utterance texts in a call including the utterance, and correct labels and inference labels of the utterance texts are associated with each other. In this manner, the utterance-specific confirmation screen generation unit 16 generates training data confirmation screens including elements included in the training data, correct labels assigned to the elements, and inference labels of the elements. Specifically, the utterance-specific confirmation screen generation unit 16 generates the training data confirmation screens indicating the correct labels and the inference labels corresponding to the elements included in the training data in a comparable manner (for example, as illustrated in FIG. 8, the correct labels and the inference labels corresponding to the elements are illustrated side by side). The utterance-specific confirmation screen generation unit 16 generates the utterance-specific confirmation screens for respective pieces of utterance in which the correct labels and the inference labels are different. In FIG. 8, a piece of utterance having a line number 41 surrounded by a dotted rectangle is a piece of utterance to be displayed. As illustrated in FIG. 8, the utterance-specific confirmation screen generation unit 16 may add a predetermined mark (“**” in FIG. 8) to an utterance text to be displayed (utterance text in which the correct label and the inference label are different). The utterance-specific confirmation screen generation unit 16 may include utterance before and after the piece of utterance to be displayed in an utterance-specific confirmation screen of the piece of utterance to be displayed. That is, the utterance-specific confirmation screen generation unit 16 may generate the utterance-specific confirmation screens including elements in which the correct labels and the inference labels are different and elements before and after the elements. FIG. 8 illustrates an example in which utterance texts having line numbers 38 to 44 are included in the utterance-specific confirmation screen in which the utterance text having the line number 41 is to be displayed.

The utterance-specific confirmation screen generation unit 16 presents the utterance-specific confirmation screens for the respective pieces of utterance in order from an utterance text including a difference pattern having the largest number of appearances among the difference patterns that are patterns in which the training data and the inference labels are different. That is, the utterance-specific confirmation screen generation unit 16 may present the utterance-specific confirmation screens in order from an element including a difference pattern having the largest number of appearances among the difference patterns that are patterns in which the training data and the inference labels are different.

In this manner, the utterance-specific inference result evaluation unit 15 included in the evaluation unit 17 compares, for each of the elements included in the training data, the correct labels assigned to the elements and the inference labels inferred by the learned model, and outputs evaluation results. Furthermore, the utterance-specific confirmation screen generation unit 16 included in the evaluation unit 17 generates and presents the training data confirmation screens for the respective elements included in the training data (utterance-specific confirmation screens) in order from an element including a difference pattern having the largest number of appearances among the difference patterns in which the correct labels and the inference labels are different.

As illustrated in FIG. 8, the utterance-specific confirmation screen generation unit 16 may present a plurality of the utterance-specific confirmation screens such that the utterance-specific confirmation screens are partially superimposed, and switch an utterance-specific confirmation screen to be displayed on the front in response to, for example, a switching operation by a worker. That is, the utterance-specific confirmation screen generation unit 16 may generate the utterance-specific confirmation screens such that confirmation can be performed in order from an element including a difference pattern having the largest number of appearances. In this way, only training data to be confirmed can be quickly confirmed in order from data having the largest influence.

By the utterance-specific confirmation screens being displayed, workers can find and correct training data including an error in the label in units of pieces of utterance. Furthermore, since elements in which the correct labels and the inference labels are different and elements before and after the elements being presented, workers can correct a label of an utterance text to be displayed in consideration of the content of the preceding and following utterance texts (elements), and thus, the efficiency of label correction work can be improved. Furthermore, by a plurality of utterance-specific confirmation screens of the same difference pattern being presented in a switchable manner, workers can continuously confirm utterance-specific confirmation screens of the same difference pattern and grasp the main point of correction for each difference pattern. As a result, the efficiency of training data correction work can be improved. Note that, instead of presenting the utterance-specific confirmation screens illustrated in FIG. 8 in a switchable manner, the utterance-specific confirmation screen generation unit 16 may divide a file group of text data corresponding to the utterance-specific confirmation screens into directories or the like and output the directories to the external output interface 1.

As described above, the support device 10 according to the present embodiment includes the label inference unit 12 and the evaluation unit 17. The label inference unit 12 infers the inference labels of the elements included in the training data using the learned model learned using the training data. The evaluation unit 17 generates the training data confirmation screens including the elements included in the training data, the correct labels assigned to the elements, and the inference labels inferred by the learned model.

Furthermore, a training data correction method according to the present embodiment includes a step of inferring labels (step S12) and steps of generating training data confirmation screens (steps S14 and S16). In the step of inferring labels, inference labels of elements included in training data are inferred using a learned model learned using the training data. In the steps of generating training data confirmation screens, training data confirmation screens including the elements included in the training data, correct labels assigned to the elements, and inference labels of the elements are generated.

In this way, according to the support device 10 and the support method according to the present embodiment, the training data can be easily confirmed by workers by the training data confirmation screens including the correct labels and the inference labels of the elements, and thus the efficiency of the training data confirmation work can be improved.

### Second Embodiment

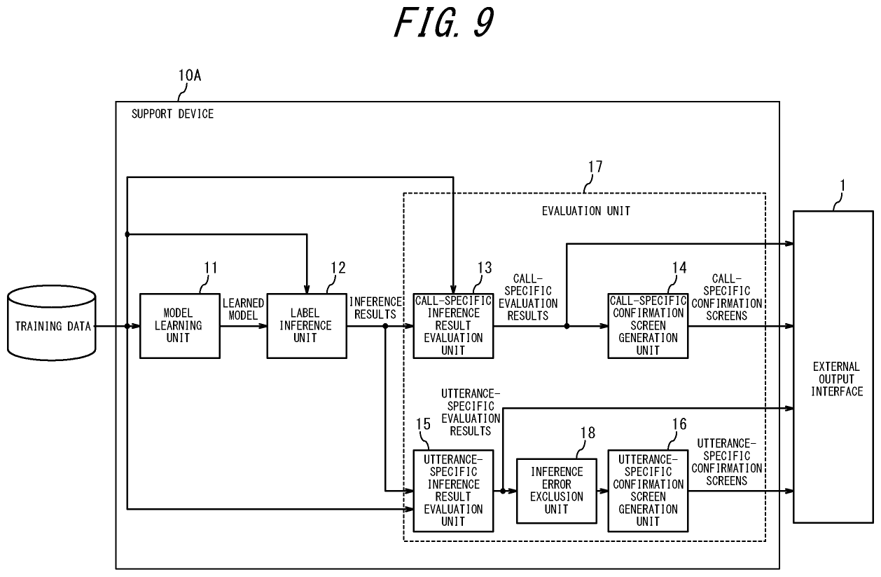

FIG. 9 is a diagram illustrating a configuration example of a support device 10A according to a second embodiment of the present disclosure. In FIG. 9, configurations similar to those in FIG. 2 are denoted by the same reference signs, and description thereof will be omitted.

The support device 10A according to the present embodiment is different from the support device 10 according to the first embodiment in that an inference error exclusion unit 18 is added.

The inference error exclusion unit 18 receives utterance-specific evaluation results by an utterance-specific inference result evaluation unit 15. The inference error exclusion unit 18 performs inference error exclusion processing of excluding an element in which the inference label inferred by a learned model is determined to be an erroneous according to a predetermined rule. Specifically, the inference error exclusion unit 18 excludes a piece of utterance having a clearly erroneous inference label from the utterance-specific evaluation results of the utterance-specific inference result evaluation unit 15. The piece of utterance that is clearly erroneous is, for example, a piece of utterance in which one scene is formed by only one piece of utterance, or a piece of utterance in which a label indicating closing indicating a call end or a response to a requirement of a customer is assigned to an utterance text although the utterance text is the opening of the call. Determination conditions of a piece of clearly erroneous utterance are manually determined in advance.

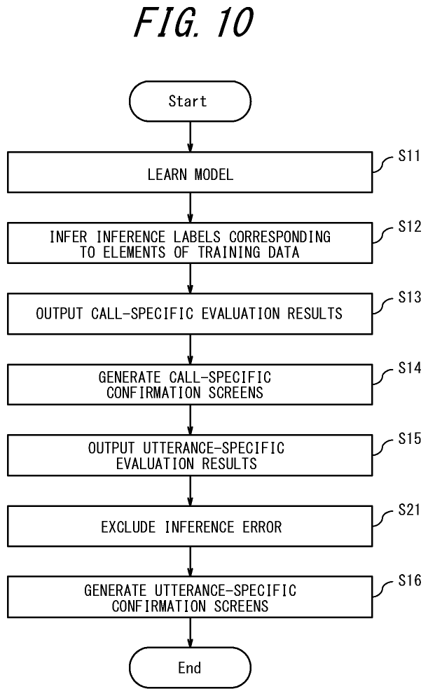

Next, operation of the support device 10A according to the present embodiment will be described. FIG. 10 is a flowchart illustrating an example of the operation of the support device 10A. In FIG. 10, processing similar to the processing in FIG. 3 is denoted by the same reference signs, and description thereof will be omitted.

When utterance-specific evaluation results are output from the utterance-specific inference result evaluation unit 15 (step S15), the inference error exclusion unit 18 excludes a piece of utterance in which the inference label inferred by the learned model is clearly erroneous from the utterance-specific evaluation results (step S21).

Note that, although, in the present embodiment, an example has been described in which the inference error exclusion unit 18 excludes a piece of utterance that is clearly erroneous from the utterance-specific evaluation results, the present disclosure is not limited thereto. In short, the inference error exclusion unit 18 may exclude a piece of utterance that is clearly erroneous from evaluation results and training data confirmation screens. Therefore, the inference error exclusion unit 18 may be provided, for example, between a label inference unit 12, and a call-specific inference result evaluation unit 13 and the utterance-specific inference result evaluation unit 15.

As described above, in the present embodiment, the support device 10A further includes the inference error exclusion unit 18 that excludes an element in which the inference label inferred by the learned model is determined to be erroneous according to a predetermined rule.

Therefore, since a clear error is excluded, the number of pieces of training data to be confirmed by workers can be reduced and the efficiency of correction work of training data can be improved.

### Third Embodiment

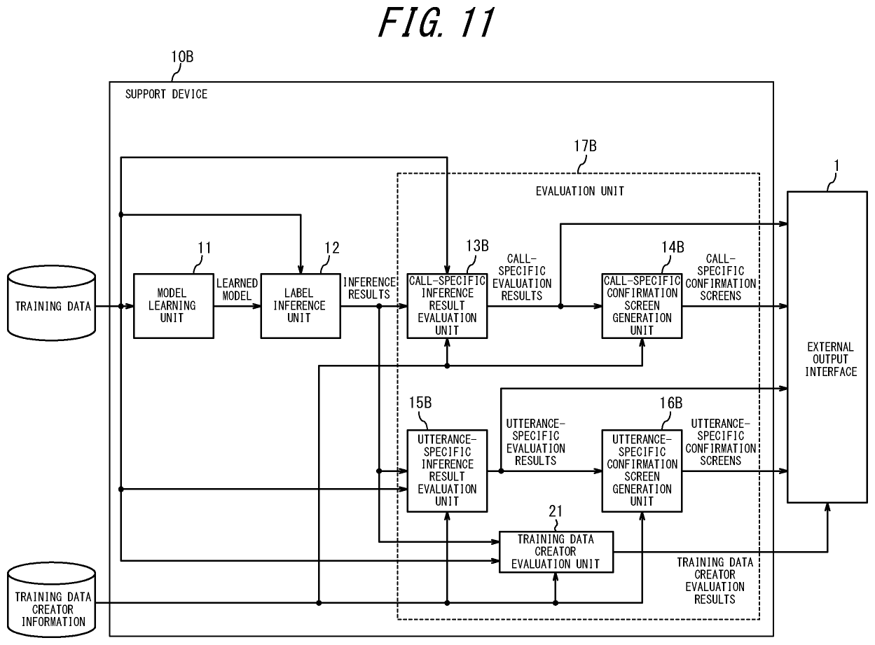

FIG. 11 is a diagram illustrating a functional configuration example of a support device 10B according to a third embodiment of the present disclosure. The support device 10B according to the present embodiment supports evaluation of training data creators who create training data by assigning labels to elements included in the training data. In FIG. 11, configurations similar to those in FIG. 2 are denoted by the same reference signs, and description thereof will be omitted.

As illustrated in FIG. 11, the support device 10B according to the present embodiment includes a model learning unit 11, a label inference unit 12, a call-specific inference result evaluation unit 13B, a call-specific confirmation screen generation unit 14B, an utterance-specific inference result evaluation unit 15B, an utterance-specific confirmation screen generation unit 16B, and a training data creator evaluation unit 21. The call-specific inference result evaluation unit 13B, the call-specific confirmation screen generation unit 14B, the utterance-specific inference result evaluation unit 15B, the utterance-specific confirmation screen generation unit 16B, and the training data creator evaluation unit 21 form an evaluation unit 17B. That is, the support device 10B according to the present embodiment is different from the support device 10 according to the first embodiment in that the call-specific inference result evaluation unit 13, the call-specific confirmation screen generation unit 14, the utterance-specific inference result evaluation unit 15, and the utterance-specific confirmation screen generation unit 16 are changed to the call-specific inference result evaluation unit 13B, the call-specific confirmation screen generation unit 14B, the utterance-specific inference result evaluation unit 15B, and the utterance-specific confirmation screen generation unit 16B, respectively, and that the training data creator evaluation unit 21 is added.

The evaluation unit 17B generates evaluation results of training data creators on the basis of comparison between correct labels of elements included in training data and inference labels of the elements inferred by the label inference unit 12. As described above, the call-specific inference result evaluation unit 13B, the call-specific confirmation screen generation unit 14B, the utterance-specific inference result evaluation unit 15B, the utterance-specific confirmation screen generation unit 16B, and the training data creator evaluation unit 21 form the evaluation unit 17B.

To the call-specific inference result evaluation unit 13B, the call-specific confirmation screen generation unit 14B, the utterance-specific inference result evaluation unit 15B, and the utterance-specific confirmation screen generation unit 16B, training data creator information that is information for identifying training data creators who have created training data used for creating a learned model is input. As described above, a large amount of training data is required for creating a model having estimation accuracy for practical use. Therefore, training data is usually created by a plurality of training data workers. The training data creator information is information for identifying each of the plurality of training data creators who have created training data.

Similarly to the call-specific inference result evaluation unit 13, the call-specific inference result evaluation unit 13B evaluates the training data and inference results of the label inference unit 12 for each call, and outputs evaluation results (call-specific evaluation results) to the call-specific confirmation screen generation unit 14B and an external output Interface 1. Here, the call-specific inference result evaluation unit 13B generates the call-specific evaluation results for each of the training data creators on the basis of the training data creator information. That is, the call-specific inference result evaluation unit 13B included in the evaluation unit 17B generates evaluation results for respective element groups obtained by comparing correct labels and inference labels of elements included in the element groups for each of the training data creators. Although details will be described below, the call-specific inference result evaluation unit 13B may present the call-specific evaluation results generated for the respective training data creators in a switchable manner.

Similarly to the call-specific confirmation screen generation unit 14, the call-specific confirmation screen generation unit 14B generates training data confirmation screens for the respective calls (call-specific confirmation screens) on the basis of the call-specific evaluation results output from the call-specific inference result evaluation unit 13B, and outputs the call-specific confirmation screens to the external output interface 1. Here, the call-specific confirmation screen generation unit 14B generates the call-specific confirmation screens for each of the training data creators on the basis of the training data creator information. That is, the call-specific confirmation screen generation unit 14B included in the evaluation unit 17B generates training data confirmation screens for the respective element groups including the elements included in the element groups, the correct labels of the elements, and the inference labels of the elements for each of the training data creators. Although details will be described below, the call-specific confirmation screen generation unit 14B may present training data confirmation screens generated for a same training data creator in a switchable manner.

Similarly to the utterance-specific inference result evaluation unit 15, the utterance-specific inference result evaluation unit 15B evaluates the training data and the inference results of the label inference unit 12 for each of pieces of utterance, and outputs evaluation results (utterance-specific evaluation results) to the utterance-specific confirmation screen generation unit 16B and an external output interface 1. That is, the utterance-specific inference result evaluation unit 15B included in the evaluation unit 17B generates evaluation results for the respective elements included in the training data based on comparison between the correct labels and the inference labels for each of the training data creators.

Similarly to the utterance-specific confirmation screen generation unit 16, the utterance-specific confirmation screen generation unit 16B generates training data confirmation screens for the respective pieces of utterance (utterance-specific confirmation screens) on the basis of the utterance-specific evaluation results output from the utterance-specific inference result evaluation unit 15B, and outputs the utterance-specific confirmation screens to the external output interface 1. Here, the utterance-specific confirmation screen generation unit 16B generates the utterance-specific confirmation screens for the respective training data creators on the basis of the training data creator information. That is, the utterance-specific confirmation screen generation unit 16B included in the evaluation unit 17B generates training data confirmation screens including the elements included in the training data, the correct labels of the elements, and the inference labels of the elements for the respective training data creators. Although details will be described below, the utterance-specific confirmation screen generation unit 16B may generate the utterance-specific confirmation screens (screens on which the evaluation results for each of the element groups can be confirmed) in a switchable manner between the training data creators.

The training data creator evaluation unit 21 receives the training data, the inference results by the label inference unit 12, and the training data creator information. The training data creator evaluation unit 21 generates evaluation results of the training data creators (hereinafter, it is referred to as “training data creator evaluation results”) on the basis of comparison between the correct labels of the elements included in the training data and the inference labels of the elements, and outputs the evaluation results to the external output interface 1.

In the present embodiment, the training data creators can be more efficiently evaluated by the evaluation results of the training data creators being generated on the basis of comparison between the correct labels assigned to the elements included in the training data and the inference labels of the elements. Furthermore, tendencies of errors at the time of creating training data can be analyzed in detail for each of the training data creators, and the training data creators can be efficiently educated for training data creation policy.

Next, operation of the support device 10B according to the present embodiment will be described.

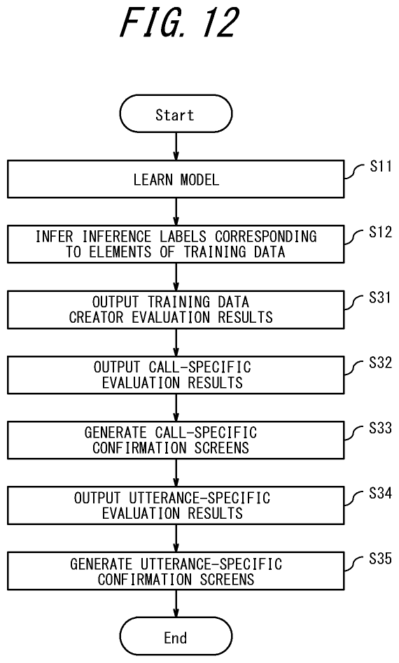

FIG. 12 is a flowchart illustrating an example of the operation of the support device 10B, and is a diagram for describing a support method by the support device 10B according to the present embodiment. In FIG. 12, processing similar to the processing in FIG. 3 is denoted by the same reference signs, and description thereof will be omitted.

When inference labels of elements included in training data are inferred by the label inference unit 12 (step S12), the training data creator evaluation unit 21 generates training data creator evaluation results on the basis of comparison between correct labels of the elements included in the training data and the inference labels of the elements, and outputs the evaluation results to the external output interface 1 (step S31).

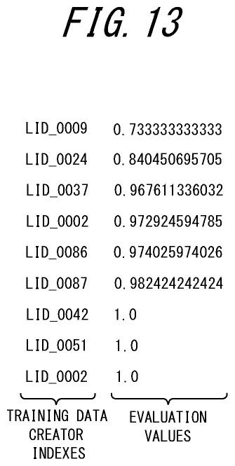

FIG. 13 is a diagram illustrating an example of the training data creator evaluation results.

As illustrated in FIG. 13, the training data creator evaluation unit 21 outputs, as the training data creator evaluation results, training data creator indexes that are identification information for identifying the training data creators and evaluation values of the training data created by the training data creators in association with each other. An evaluation value of training data is, for example, an average value of values of precision, recall, f1-scores, matching rates, or the like of inference labels for correct labels of a plurality of pieces of training data created by a training data creator. That is, the training data creator evaluation unit 21 generates the evaluation results for the respective element groups based on comparison between the correct labels and the inference labels corresponding to the elements included in element groups such that the evaluation results can be confirmed for each of the training data creators. It is considered that a training data creator having a high evaluation value of created training data is highly likely to assign appropriate labels. On the other hand, it is considered that a training data creator having a low evaluation value of created training data is not able to assign appropriate labels, and there is a high possibility that training such as learning of a policy of assigning labels is required. For example, the training data creator evaluation unit 21 outputs the training data creator indexes and the evaluation values in order from the worst evaluation value. As a result, a training data creator who creates training data having low quality and is likely to require the training such as learning of the policy of assigning labels can be easily grasped.

Referring back to FIG. 12, the call-specific inference result evaluation unit 13B evaluates the correct labels of the training data and the inference results of the label inference unit 12 for each of the calls, and outputs call-specific evaluation results (step S32).

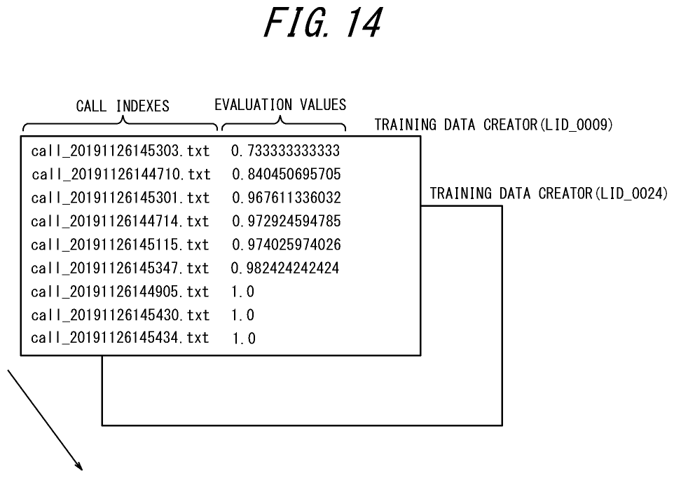

FIG. 14 is a diagram illustrating an example of the call-specific inference results output by the call-specific inference result evaluation unit 13B.

As illustrated in FIG. 14, similarly to the call-specific inference result evaluation unit 13, the call-specific inference result evaluation unit 13B outputs, as the call-specific evaluation results, call indexes and evaluation values such as matching rates in the calls in association with each other. Furthermore, similarly to the call-specific inference result evaluation unit 13, the call-specific inference result evaluation unit 13B may list the call indexes and the evaluation values in order from the worst evaluation result, and output the list as text data, for example. The call-specific evaluation results may include the start time and the end time of the calls.

As illustrated in FIG. 14, the call-specific inference result evaluation unit 13B generates the call-specific evaluation results for the respective training data creators. The call-specific inference result evaluation unit 13 may present the call-specific evaluation results for the respective training data creators in a switchable manner. By the call-specific evaluation results for the respective training data creators being generated, tendencies of label assignment for each of the training data creators can be easily grasped.

Referring back to FIG. 12, the call-specific confirmation screen generation unit 14B generates call-specific confirmation screens on the basis of the call-specific evaluation results (step S33) and outputs the screens to the external output interface 1.

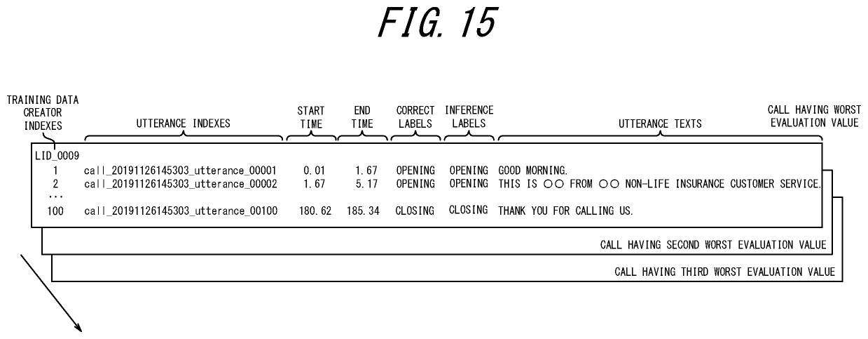

FIG. 15 is a diagram illustrating an example of the call-specific confirmation screens.

As illustrated in FIG. 15, similarly to the call-specific confirmation screen generation unit 14, the call-specific confirmation screen generation unit 14B generates the call-specific confirmation screens for respective calls each including start time of utterance included in the call, end time of the utterance, utterance texts, and correct labels and inference labels of the utterance texts. Here, the call-specific confirmation screen generation unit 14B generates the call-specific confirmation screens for each of the training data creators. The call-specific confirmation screen generation unit 14B includes the training data creator indexes in the call-specific confirmation screens as illustrated in FIG. 15 in order to indicate for which training data creators the call-specific confirmation screens have been generated. As illustrated in FIG. 15, the call-specific confirmation screen generation unit 14B may superimposedly present call-specific confirmation screens generated for the same training data creator in a switchable manner. That is, the call-specific confirmation screen generation unit 14B may generate the training data confirmation screens for the respective element groups (call-specific confirmation screens) including the elements included in the element groups, the correct labels corresponding to the elements, and the inference labels of the elements and are switchable between the element groups for each of the training data creators. In this case, the call-specific confirmation screen generation unit 14B may display the call-specific confirmation screens such that a call having a worse evaluation result is closer to the front.

Referring back to FIG. 12, the utterance-specific inference result evaluation unit 15B evaluates the training data and the inference results of the label inference unit 12 for each piece of the utterance, and outputs evaluation results (utterance-specific evaluation results) (step S34).

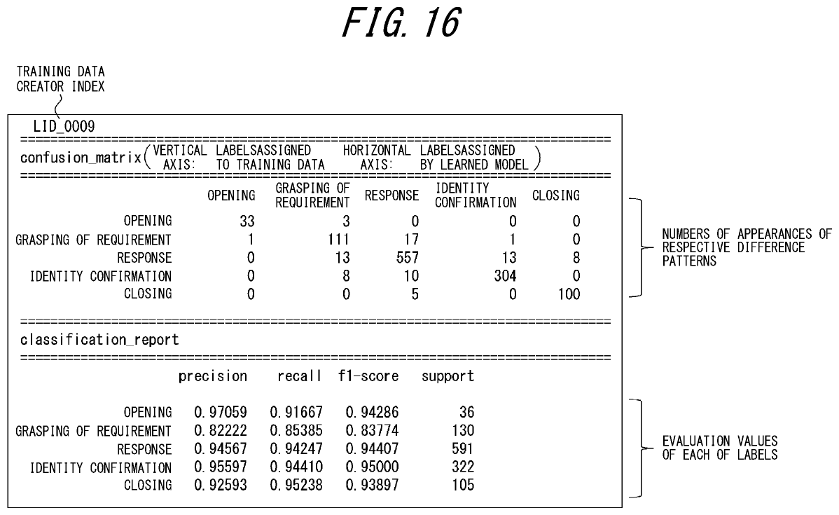

FIG. 16 is a diagram illustrating an example of the utterance-specific evaluation results.

As illustrated in FIG. 16, similarly to the utterance-specific inference result evaluation unit 15, the utterance-specific inference result evaluation unit 15B outputs, as the utterance-specific evaluation results, for example, results indicating the numbers of appearances of difference patterns by a confusion matrix and evaluation values of each of the labels (precision, recall, f1-score, and number of appearances (support)) as text data. Here, the utterance-specific inference result evaluation unit 15B outputs the utterance-specific evaluation results for the respective training data creators. The utterance-specific inference result evaluation unit 15B includes the training data creator indexes in the utterance-specific evaluation results as illustrated in FIG. 16 in order to indicate for which training data creators the utterance-specific evaluation results have been generated. By the utterance-specific evaluation results for the respective training data creators being output, difference patterns in which each of the training data creators is likely to make errors in assigning labels can be confirmed. Furthermore, the training data creators or the manager can easily grasp errors of the policy of assigning labels. As described above, the utterance-specific evaluation results include evaluation results of the training data created by the training data creators, such as the appearance frequencies of the difference patterns and evaluation values for each of the labels. Therefore, the utterance-specific evaluation results may be output as the training data creator evaluation results.

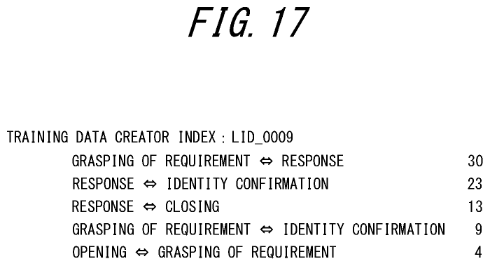

Note that the utterance-specific inference result evaluation unit 15B may indicate, in a ranking format, difference patterns in which confusion is likely to occur as illustrated in FIG. 17 instead of the evaluation values for each of the labels illustrated in FIG. 16. The difference patterns in which confusion is likely to occur are patterns in which the correct labels and the inference labels are different from each other, and are patterns in which confusion or replacement is likely to occur. The number of a difference pattern in which confusion is likely to occur is, for example, the total of the number of pieces of utterance having a correct label of A and an inference label of B and pieces of utterance having a correct label of B and an inference label of A. Furthermore, the utterance-specific inference result evaluation unit 15B may include the difference patterns in which confusion is likely to occur in the utterance-specific evaluation results. In this way, the training data creators can grasp the difference patterns that are likely to be erroneous (labels for which appropriate assignment is difficult). Furthermore, the manager of the training data creators can notice recognition errors of the policy of assigning labels for each of the training data creators.

Referring back to FIG. 12, the utterance-specific confirmation screen generation unit 16B generates utterance-specific confirmation screens on the basis of the utterance-specific evaluation results (step S35) and outputs the screens to the external output interface 1.

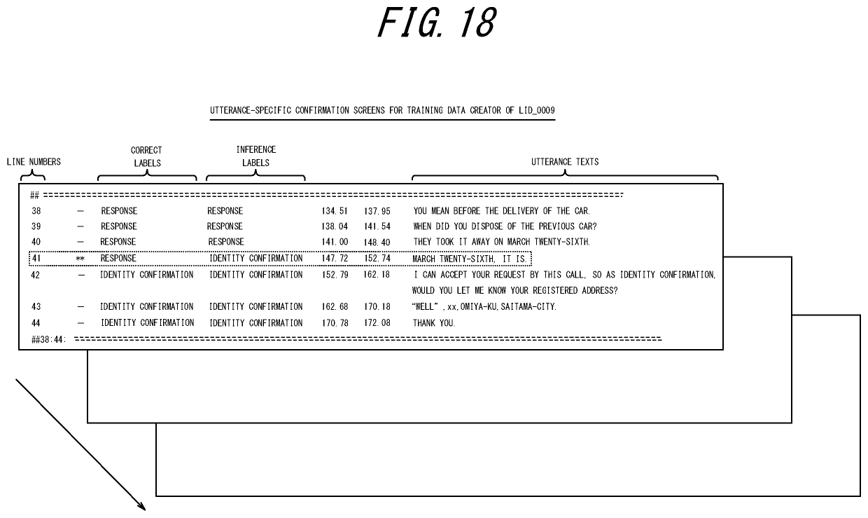

FIG. 18 is a diagram illustrating an example of the utterance-specific confirmation screens.

As illustrated in FIG. 18, similarly to the utterance-specific confirmation screen generation unit 16, the utterance-specific confirmation screen generation unit 16B generates the utterance-specific confirmation screens in which the utterance texts, line numbers indicating the order of the utterance texts in a call including the utterance, and the correct labels and the inference labels of the utterance texts are associated with each other. Here, the utterance-specific confirmation screen generation unit 16B generates the utterance-specific confirmation screens for each of the training data creators. That is, the utterance-specific confirmation screen generation unit 16B generates training data confirmation screens for the respective elements (utterance-specific confirmation screens) including the elements, the correct labels corresponding to the elements, and the inference labels of the elements such that the training data confirmation screens can be confirmed for each of the training data creators.

Note that, similarly to the utterance-specific confirmation screen generation unit 16, the utterance-specific confirmation screen generation unit 16B may generate and present the utterance-specific confirmation screens in order from an utterance text including a difference pattern having the largest number of appearances. That is, the utterance-specific confirmation screen generation unit 16B may present the utterance-specific confirmation screens in order from an element including a difference pattern having the largest number of appearances among the difference patterns that are patterns in which the correct labels assigned to the training data and the inference labels by the learned model are different. Furthermore, the utterance-specific confirmation screen generation unit 16B may present a plurality of utterance-specific confirmation screens generated for the same training data creator in a switchable manner.

As described above, the support device 10B according to the present embodiment includes the label inference unit 12 and the evaluation unit 17B. The label inference unit 12 infers inference labels that are labels corresponding to elements included in training data using a model that is learned using the training data and infers the labels corresponding to the elements. The evaluation unit 17 generates evaluation results of training data creators on the basis of comparison between correct labels of the elements included in the training data and the inference labels of the elements.

Furthermore, a support method according to the present embodiment includes a step of inferring and a step of generating evaluation results. In the step of inferring, inference labels that are labels corresponding to elements included in training data are inferred using a model that is learned using the training data and infers labels corresponding to the elements. In the step of generating evaluation results, evaluation results of training data creators are generated on the basis of comparison between correct labels of the elements included in the training data and the inference labels of the elements.

The training data creators can be more efficiently evaluated by the evaluation results of the training data creators being generated on the basis of comparison between the correct labels of the elements included in the training data and the inference labels of the elements. Furthermore, tendencies of errors at the time of creating the training data can be analyzed in detail for each of the training data creators, and the training data creators can be efficiently educated for the creation policy.

A computer can be suitably used to function as each unit of the support devices 10, 10A, and 10B described above. Such a computer can be implemented by storing a program in which processing contents for implementing the function of each unit of the support devices 10, 10A, and 10B are described in a storage unit of the computer and reading and executing the program by a central processing unit (CPU) of the computer. That is, the program can cause the computer to function as the support devices 10, 10A, and 10B described above.

With regard to the above embodiments, the following supplementary notes are further disclosed.

(Supplement 1)

A support device including
a memory, and
at least one processor connected to the memory,
in which the processor infers inference labels that are labels corresponding to elements included in training data including sets of elements and correct labels corresponding to the elements using a model that is learned using the training data and infers labels corresponding to the elements, and
generates a training data confirmation screen including elements included in the training data, correct labels of elements, and inference labels of the elements.

(Supplement 2)

A non-transitory storage medium that stores a program that can be executed by a computer, the non-transitory storage medium causing the computer to function as the support device according to the supplement 1.

All documents, patent applications, and technical standards described in this specification are incorporated herein by reference to the same extent as if each individual document, patent application, and technical standard were specifically and individually described to be incorporated by reference.

### REFERENCE SIGNS LIST

10, 10A, 10B Support device
11 Model learning unit
12 Label inference unit
13, 13B Call-specific inference result evaluation unit
14, 14B Call-specific confirmation screen generation unit
15, 15B Utterance-specific inference result evaluation unit
16, 16B Utterance-specific confirmation screen generation unit
17 Evaluation unit
18 Inference error exclusion unit
21 Training data creator evaluation unit
110 Processor
120 ROM
130 RAM
140 Storage
150 Input unit
160 Display unit
170 Communication interface
190 Bus

1. A support device for supporting confirmation of training data including sets of elements and correct labels corresponding to the elements, the support device comprising processing circuitry configured to:
infer inference labels that are labels corresponding to elements included in the training data using a model that is learned using the training data and infers labels corresponding to the elements; and
generate training data confirmation screens including elements included in the training data, correct labels of the elements, and inference labels of the elements.

2. The support device according to claim 1,
wherein the processing circuitry generates the training data confirmation screens indicating the correct labels and the inference labels corresponding to elements included in the training data in a comparable manner.

3. The support device according to claim 1,
wherein the training data includes a plurality of element groups each including a plurality of elements in series, and
the processing circuitry evaluates, for each element group, differences between correct labels of elements included in a corresponding element group and the inference labels, and generates the training data confirmation screens for respective element groups such that confirmation can be performed in order from the element group having a worst evaluation result.

4. The support device according to claim 1,
wherein the processing circuitry generates the training data confirmation screens for respective elements included in the training data such that confirmation can be performed in order from an element including a difference pattern having a largest number of appearances among difference patterns that are patterns in which the correct labels and the inference labels are different.

5. The support device according to claim 1,
wherein the processing circuitry excludes an element in which a label inferred by the model is determined to be erroneous according to a predetermined rule.

6. The support device according to claim 1,
wherein the processing circuitry generates, for a plurality of the elements in which the correct labels and the inference labels are different, the training data confirmation screens such that the training data confirmation screens for the respective elements are switchable.

7. The support device according to claim 1,
wherein the processing circuitry generates the training data confirmation screens including elements in which the correct labels and the inference labels are different and elements before and after the elements.

8. A support method for supporting confirmation of training data including sets of elements and correct labels corresponding to the elements, the support method comprising:
inferring inference labels that are labels corresponding to elements included in the training data using a model that is learned using the training data and infers labels corresponding to the elements; and
generating training data confirmation screens including elements included in the training data, correct labels of the elements, and inference labels of the elements.

9. A non-transitory computer readable recording medium recording a program for causing a computer to function as the support device according to claim 1.
